(19) United States
(12) Patent Application Publication
(10) Pub. No.: US 2005/0134691 A1
(43) Pub. Date: Jun. 23, 2005

(54) Method and system for a communication device having a single button photo send

(76) Inventor: Earl Clyde Cox, La Crescenta, CA (US)

Correspondence Address: MCANDREWS HELD & MALLOY, LTD, 500 WEST MADISON STREET, SUITE 3400, CHICAGO, IL, 60661, US

(21) Appl. No.: 10/744,488

(22) Filed: Dec. 23, 2003

(51) Int. Cl. G06F 7/00

(52) U.S. Cl. 348/207.99; 348/231.6; 396/72; 707/3

(57) ABSTRACT

Aspects of the invention may be found in a method and system for processing an image by a consumer handheld communication device and may comprise receiving an indication that a capture and send function is activated and capturing at least one image by the consumer handheld communication device. The consumer handheld communication device may wirelessly transfer at least one captured image to a policing authority and/or a service provider providing wireless service for the consumer handheld communication device. An audio and/or a visual signal may be displayed while capturing the image. The capture and send function may be activated by a single button. If the capture and send function is activated for a specified period, then a special emergency number may also be dialed.

### CROSS-REFERENCE TO RELATED APPLICATIONS/INCORPORATION BY REFERENCE

Not Applicable.

### FIELD OF THE INVENTION

Certain embodiments of the invention relate to wireless consumer communication devices. More specifically, certain embodiments of the invention relate to a method and system for a communication device having a single button for capturing and sending images in a single operation.

### BACKGROUND OF THE INVENTION

The development and deployment of new wireless technologies and increased bandwidth has spawned a new breed of wireless devices which have the capability to exploit these new wireless technologies. These wireless devices include cellular telephones, personal digital assistants, smart phones and other handheld type wireless communication devices. Smart phones are hybrid communication devices having at least some of the capabilities and features of a cellular telephone and at least some of the capabilities and features of a personal digital assistant. For example, a smart phone may have an operating system (OS), enhanced display, and input/output (I/O) expansion slots, in addition to some of the traditional telephone functions. The operating system may be adapted to facilitate integration of voice and data services such as dialing directly from a telephone address book and displaying a calling party's information. The enhanced display may, for example, be a high resolution color display, which may have touch screen capability.

Some of these wireless devices comprise a camera that may be capable of taking still photographs and/or short video clips. Accordingly, software running on the operating system may be utilized to control operation of the camera. In some instances, the wireless device has to be opened and special menu keys and/or navigational keys accessed and utilized to initiate operation of the camera software. Once the camera is initialized, various software functions may be utilized to capture and either store a photograph or video clip on the wireless device or transfer the image to a remote system or device. The software functions may be accessed through, for example, pull down lists, menus and/or icons. Hence, in order to take a quick photograph, a user has to open the telephone, navigate through various menus using the pull down lists and/or icons to initialize or activate the camera, and then take the photograph. This can be a very cumbersome task and in certain instances, the scene may have changed or a subject of the photograph may have moved and accordingly, it may be too late or impossible to capture the scene and/or subject.

For images that are captured and stored on the wireless device, the images may be stored in an internal memory or on a removable memory card such as a secure digital (SD) card. If captured images are stored in the internal memory of the wireless device, these captured images have to be transferred to a remote system or other wireless device using one or more software applications. For example, the captured images may be emailed to a user on a remote system or the captured images may be uploaded to a service provider's server. This may require utilizing, for example, an email application to attach the captured images to one or more emails and sending the email to its intended recipients. If captured images are stored in a removable memory card, then the memory card must be removed, taken to a different device or system, and uploaded onto the new device or system.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Certain embodiments of the invention may be found in a method and system for a communication device having a single button for capturing and sending images in a single operation. Certain aspects of the invention may also be found in a method and system for processing an image by a consumer handheld communication device. The method may comprise receiving an indication that a capture and send function is activated and capturing at least one image by the consumer handheld communication device. The consumer handheld communication device may wirelessly transfer at least one captured image to a policing authority and/or a service provider providing wireless service for the consumer handheld communication device. An audio and/or a visual signal may be displayed while capturing the image. The indication may be a signal generated by the depression or activation of at least one button.

Configuration settings for capturing the image may be determined and a camera for the consumer handheld communication device may be initialized utilizing at least a portion of the determined configuration settings. The camera may also be initialized utilizing default configuration settings. At least one high priority data packet may be generated for transferring the captured image and the generated high priority data packet may be placed at the top of a send queue for immediate sending. The captured image may be stored at the consumer handheld communication device in an internal memory and/or on a removable storage. A flash bulb that illuminates the subject with a flash of light may be generated while capturing the image. The captured image may be a still or a video clip.

In another embodiment of the invention, an interval for which the received indication is active may be determined. If the determined interval is at least equivalent to a specified time period, at least one directory number may be dialed. The directory number that is dialed may be a local emergency number, a default directory number and/or a user specified directory number.

Another embodiment of the invention may provide a machine-readable storage, having stored thereon, a computer program having at least one code section for processing an image by a consumer handheld communication device. The at least one code section may be executable by a machine, thereby causing the machine to perform the steps as described above regarding processing an image by a consumer handheld communication device.

Aspects of the system for processing an image by a consumer handheld communication device may comprise at least one processor that receives an indication that a capture and send function is activated. The processor may be a RISC processor, a MIPS processor, CPU, ARM processor, DSP, ASIC, microprocessor, microcontroller, or other type of processor. A camera may be configured to capture at least one image and a wireless transceiver may wirelessly transfer the captured image from the consumer handheld communication device to a policing authority and/or a service provider providing wireless service for the consumer handheld communication device. The captured image may be a still or a video clip. A display is provided which may display a visual signal and a speaker may be utilized to play back an audio signal during capture of the image. The processor may determine configuration settings for capturing the image and utilize at least a portion of the determined configuration settings to initialize the camera and/or the consumer handheld communication device. The processor may also initialize the camera utilizing default configuration settings. The service provider may be a telephone, cable, and/or Internet service provider that may provide wired and/or wireless service.

At least one high priority data packet may be generated by the processor and utilized for transferring the captured image. The processor may place the generated high priority data packet at the top of a send queue for immediate sending. An internal memory and/or a removable storage may be utilized for storing the captured image on the consumer handheld communication device. The processor may also be configured with a flash bulb device that illuminates the subject with a flash of light while capturing the image.

In another embodiment of the invention, the processor may determine an interval for which the received indication is active. If the determined interval is at least equivalent to a specified time period, the processor may dial at least one directory number. The directory number dialed by the processor may be a local emergency number, a default directory number and/or a user specified directory number.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1a is a block diagram of a front view of an exemplary device comprising a single button for capturing and sending an image in accordance with an embodiment of the invention.

FIG. 1b is a block diagram of a rear view of the exemplary device of FIG. 1a comprising a single button for capturing and sending an image in accordance with an embodiment of the invention.

FIG. 2 is a flowchart illustrating exemplary steps that may be utilized for one button capture and send in a single operation in accordance with an embodiment of the invention.

FIG. 3 is a block diagram of a rear view of an alternative embodiment of an exemplary device of FIG. 1a, which comprises a single button for capturing and sending an image in accordance with an embodiment of the invention.

FIG. 4 is a block diagram of an exemplary wireless device comprising a single button for capturing and sending an image in accordance with an embodiment of the invention.

### DETAILED DESCRIPTION OF THE INVENTION

Aspects of the invention may also be found in a method and system for processing an image by a consumer handheld communication device and may comprise receiving an indication that a capture and send function is activated and capturing at least one image by the consumer handheld communication device. The consumer handheld communication device may wirelessly transfer at least one captured image to a policing authority and/or a service provider providing wireless service for the consumer handheld communication device. An audio and/or a visual signal may be displayed while capturing the image. The capture and send function may be activated by a single button. If the capture and send function is activated for a specified period, then a special emergency number may also be dialed. In this regard, if a capture and send function button is depressed for a specified period such as for five (5) seconds, then the handheld communication device may dial at least one emergency number or other number.

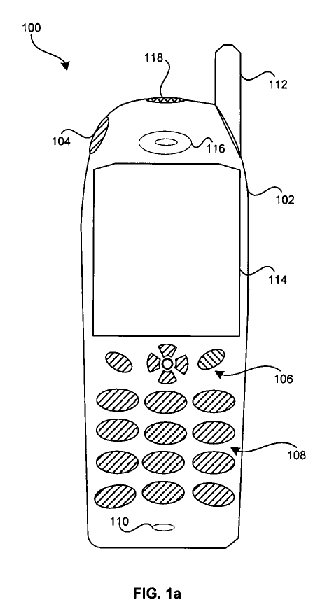

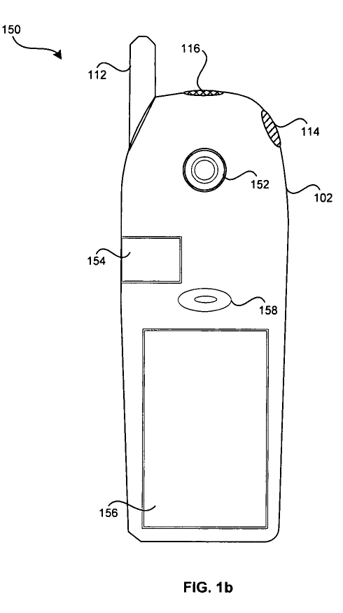

FIG. 1a is a block diagram 100 of a front view of an exemplary device comprising a single button for capturing and sending an image in accordance with an embodiment of the invention. Referring to FIG. 1a, the exemplary device may be embodied in, for example, a wireless telephone 102, comprising a capture and send button 104, navigation and software function buttons 106, alphanumeric and symbol keys 108, microphone 110, antenna 112, display 114, speaker 116 and an IR interface 118. Although a wireless telephone 102 is illustrated, the invention is not so limited and accordingly, the exemplary device may be a smart phone, personal digital assistant or other handheld device such as a personal communicator or messaging device. The exemplary device may be adapted to utilize any one or combination of the following exemplary wireless technologies: GSM and its variants, CDMA or other spread spectrum technology and its variants, AMPS and its variants, 802.11a, 802.11b, 802.11g and Bluetooth, 2-way paging, PDC, PHS, CDPD, Mobitex, Ardis, IDEN, and/or any data protocol associated with any of these wireless technologies. For example, in a case where GSM is utilized, data may be transferred via HSCDS and/or GPRS. These wireless technologies may operate in one or more of a plurality of frequency bands including, but not limited to, 900 MHz, 1800 MHz, 1900 MHz and 2.4 GHz.

The capture and send button 104 may be a button that may be suitably integrated and located on the side, on the face or on the rear of the exemplary device such as the wireless telephone 102. Although the capture and send button 104 may be situated in a location where it may be easily accessed, it may be located in a position in which it may not be erroneously depressed. Accordingly, this may prevent unwanted capturing and sending of images if the single capture and send button 104 is depressed. In this regard, the capture and send button 104 may be recessed into either of the side, face and/or rear of the exemplary device such as the wireless telephone 102.

The navigation and software function buttons 106 may include a plurality of buttons that may be adapted to control preset and/or software enabled functions. In this regard, the navigation and software function buttons 106 may be utilized to navigate through various menu lists and/or select and open icons displayed on the display 114. The navigation and software function buttons 106 may also be utilized to navigate through a software provided keyboard that may be presented on the display 114. The navigation and software function buttons 106 may also be utilized for browsing since the exemplary device such as the wireless telephone 102, may comprise an integrated WAP 2.0/XHTML browser, for example.

The alphanumeric and symbol keys 108 are similar to the alphanumeric and symbol keys found on conventional wireless telephones and/or smart phones and may be utilized for inputting data and/or instructions into the exemplary device such as the wireless telephone 102. Various combinations of the alphanumeric and symbol keys 108 may also be adapted to initiate and execute certain functions. For example, in addition to utilizing a single capture and send button 104, simultaneously holding down or depressing one or more keys such as a “*” and a “#” key may be utilized to initiate and execute a capture and send image function.

In general, the alphanumeric and symbol keys 108 may be utilized to program various operations and function of the exemplary device such as the wireless telephone 102. In particular, the alphanumeric and symbol keys 108 may be utilized to program various parameters that may be adapted to control operation of the capture and send functions. For example, setting up the capture and send functions may require that the following parameters be set: capture still image of movie clip; the number of pictures to capture; location(s) of where to send the captures picture(s); and whether to capture images along with accompanying audio. Notwithstanding, if no parameter is set, then default parameters may be utilized. The location of where to send the picture may be, for example, a policing authority such as the local police, sheriff or FBI, and/or a secure service provider server. In instances where an image may be sent to a secure service provider server, a warrant or subpoena may have to he issued prior to the service provider turning over or transferring the image to the policing authority.

The microphone 110 may be a conventional microphone that may be adapted to convert voice into electrical signals in order to facilitate communication during a conversation. The microphone 110 in conjunction with voice recognition hardware, firmware and/or software may be adapted to facilitate voice recognition that may be utilized, for example, to navigate menus, to execute functions and/or to store voice notes. In this regard, the exemplary device such as the wireless telephone 102 may comprise a voice recognition engine to facilitate navigating menus, executing functions and/or for storing voice notes. In an embodiment of the invention, the microphone may be further adapted to initiate and execute a voice activated capture and send image function. Hence, after training the exemplary device such as the wireless telephone 102 to recognize a user's voice, the exemplary device such as the wireless telephone 102 may be programmed to automatically activate the capture and send image function based on the user's voice commands.

The antenna 112 is similar to other conventional antennas that may be utilized for transmitting and receiving signals over the air. The antenna 112 may be a retractable antenna or a non-retractable type antenna.

The display 114 may be similar to a standardized telephone, smart phone or other communication device display and may be a black and white or color TFT liquid crystal display (LCD) or other similar type of display. The display 114 may also have the capability of displaying, for example, 65,536 colors. The display 114 may be configured to display menu functions in the form or lists or icons, for example which may be utilized for controlling the execution of applications. In accordance with an embodiment of the invention, the display 114 maybe adapted to function as a viewfinder while a camera for the exemplary device such as the wireless telephone 102 is operating.

The speaker 116 may be a standard speaker that may be utilized to facilitate playing audio such as voice during a conversation. The speaker 116 may be a polyphonic type speaker having the capability to play MIDI ring tones, melodies and/or notes. Additionally, the speaker 116 may be adapted to playback cues that may be utilized for controlling the operation of the exemplary device such as the wireless telephone 102.

The IR interface 118 may comprise a standardized IR transceiver interface that may be adapted to transmit and receive IR signals. The IR interface 118 may facilitate communication with other communication devices such as other cellular telephones, smart phones and personal digital assistants, or peripherals. With regard to peripherals, the IR interface 118 may be adapted to facilitate communication with, for example, a printer. Accordingly, an image stored within a memory of the wireless device or on a removable storage plugged into the wireless device may be printed on a printer utilizing the IR interface 118.

In another embodiment of the invention, one or more of the navigation and software function buttons 106 and/or alphanumeric and symbol keys 108 that may be specially programmed to function as a single capture and send button. Accordingly, a single one or a combination of the function buttons 106 and/or alphanumeric and symbol keys 108 may be adapted to function in a manner similar to a single capture and send button 104.

FIG. 1b is a block diagram 150 of a rear view of the exemplary device of FIG. 1a comprising a single button for capturing and sending an image in accordance with an embodiment of the invention. Referring to FIG. 1b, the exemplary device may further comprise a camera 152, an expansion card 154, and a battery compartment housing a battery 156. The exemplary device may further comprise an optional rear speaker 158.

The camera 152 may be an integrated VGA digital CMOS or CCD camera capable of capturing images at various resolutions such as 640×480. The images captured by the camera 152 may be stored in an internal memory of the exemplary device such as the wireless telephone 102 or in an expansion card such as a memory card inserted into the exemplary device. The camera 152 may be adapted to capture, for example, H.263 video inside 3 GP file format at 15 frames per second (fps). Accordingly, the exemplary device such as the wireless telephone 102 may have the capability to playback H.263 video and/or any MPEG-based video formats. In another aspect of the invention, the camera 152 may be adapted to capture a series of consecutive images resulting in a series of slides. The time interval between the capture of each consecutive slide may be preset or may be user adjustable.

The expansion card 154 may be, for example, a compact flash card, a secure digital I/O (SDIO) card or other similar type of storage device. Accordingly, images generated by the camera 152 may be stored, for example, on the expansion card 154. Images and/or other data stored on the expansion card may be transferred to another communication device by removing and relocating the expansion card into the latter communication device. The images and/or other data stored on the expansion card may also be transferred wirelessly via the antenna, via the IR interface 118, or via a cable coupled to the exemplary device such as the wireless telephone 102.

The battery 156 in the battery compartment may be any standardized battery that may be adapted to supply suitable voltage and current to sustain operations of the exemplary device such as the wireless telephone 102.

The optional rear speaker 158 may be a standard speaker that may be utilized, for example, to playback an audio signal indicating that an image is being generated whenever an image is being captured and sent. Alternatively, the optional rear speaker 158 may be a polyphonic type speaker having the capability to play MIDI ring tones, melodies or notes. Additionally, the speaker 158 may be further adapted to playback cues that may be utilized to facilitate operation of the exemplary device such as the telephone 102 and may also serve as a speaker. The operation of the optional speaker may be disabled, for example, in software or via a switch or button.

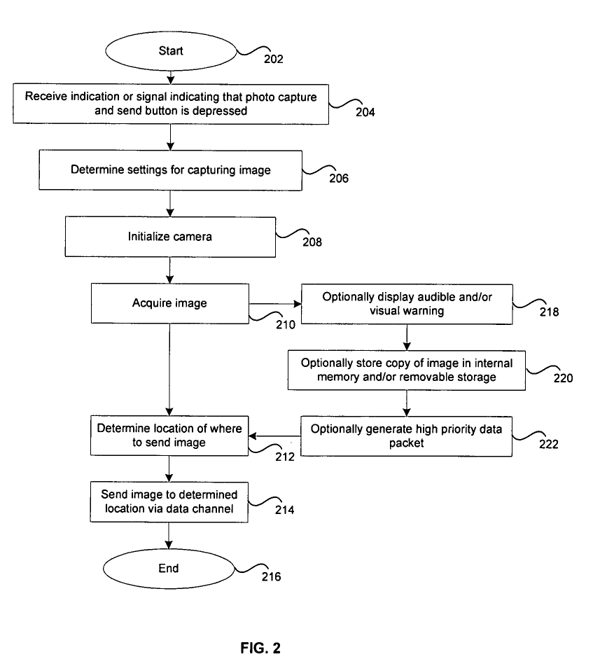

FIG. 2 is a flowchart illustrating exemplary steps that may be utilized for one button capture and send in a single operation in accordance with an embodiment of the invention. Referring to FIG. 2, the exemplary steps may start at step 202. Subsequently, in step 204, a signal or other indicator may be received indicating that a photo capture and send button is depressed. In step 206, settings for capturing an image may be determined. In step 208, the determined settings may be utilized to initialize the camera. In step 210, the image may be acquired. In step 212, the location of where to send the image maybe determined. In step 214, the image may be sent or transferred to the determined location and the exemplary steps may end at step 216. In step 218, while the image is being acquired in step 210, an optional audible and/or a visual warning may be displayed. In step 220, a copy of the captured image may be stored in an internal memory and/or removable storage.

In step 206, if no settings are determined, then default settings may be utilized to initialize the camera. In an illustrative embodiment of the invention, the default settings may comprise, capturing a series of four consecutive images with accompanied audio and transferring the captured images to a local police server. In another example, a single picture may be captured and stored in the wireless server provider's server. Notwithstanding, after the image is acquired in step 210, a high priority data packet may be generated and the generated data packet may be sent to the determined or default location. The high priority data packet may be placed at the top of a transmit queue so that it may be sent immediately to an appropriate policing authority.

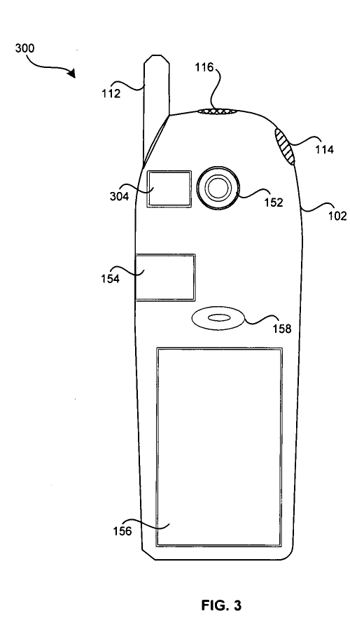

FIG. 3 is a block diagram 300 of a rear view of an alternative embodiment of an exemplary device of FIG. 1a, which comprises a single button for capturing and sending an image in accordance with an embodiment of the invention. Referring to FIG. 3, the exemplary device may further comprise a camera 152, an expansion card 154, a battery compartment housing a battery 156, an optional rear speaker 158 and an electronic flash bulb 304. In this regard, the rear view of the exemplary device illustrated in FIG. 3 comprises similar components as the rear view of the exemplary device FIG. 1b, but further comprises the electronic flash bulb 304.

The electronic flash bulb 304 may be a conventional type flash device or a LED type flash that may be operated in a manual mode or an automatic mode. The manual mode may be utilized to enhance battery life since the electronic flash bulb may only operate when it is manually turned on. In automatic mode, the electronic flash bulb 304 may be adapted to be turned on whenever it is determined that an image to be captured by the CCD camera is underexposed or is insufficiently lit. Accordingly, when the image capture and send function is activated, the electronic flash bulb 304 may be set to operate in automatic mode to ensure that a subject is properly illuminated. If for example, it is determined that there is insufficient power to illuminate the flash bulb during a capture and send operation, then an image or series of images may be captured without illuminating the electronic flash bulb 304. During consecutive image capture which may result in a series of slides, the electronic flash bulb 304 may be adapted to operate in a multiple burst mode in which the electronic flash bulb 304 may be turned one multiple times to capture each consecutive image. The electronic flash bulb 304 may be illuminated even if sufficient ambient light exists to illuminate the subject, just for the effect of clearly informing the subject that the photo has been taken.

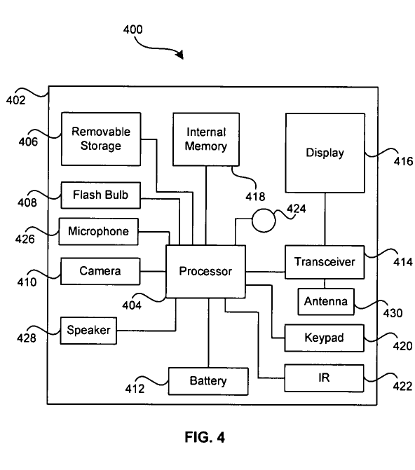

FIG. 4 is a block diagram 400 of an exemplary wireless device 402 comprising a single button for capturing and sending an image in accordance with an embodiment of the invention. Referring to FIG. 1a, the exemplary wireless device 402 may be a consumer handheld device and may comprise a processor 404, a removable storage 46, a flash bulb 408, a camera 410, a battery 412, a transceiver 414, a display 416, an internal memory 418, and keypad 420, and IR interface 422, a camera 424, a microphone 426, a speaker 428 and an antenna 430. The keypad 420 may comprise alphanumeric keys, symbols keys, and navigation and function buttons. The flash bulb may be a LED or other conventional type of flash bulb.

In an embodiment of the invention, the processor 404 may receive an indication that a capture and send function is activated. The camera 410 may be configured to capture at least one image and the wireless transceiver 414 may wirelessly transfer the captured image from the consumer handheld communication device 402 to a policing authority and/or a service provider providing wireless service for the consumer handheld communication device. The captured image may be a still or a video clip. Notwithstanding, the display 416 may display a visual signal and the speaker 428 may playback an audio signal during capture of the image. The processor 404 may determine configuration settings for capturing the image and utilize at least a portion of the determined configuration settings to initialize the camera 410 and/or the consumer handheld communication device 402. The processor 404 may also initialize the camera 410 utilizing default configuration settings.

At least one high priority data packet may be generated by the processor 404 for transferring the captured image and the generated high priority data packet may be placed at the top of a send queue for immediate sending. An internal memory 418 and/or a removable storage 406 may be utilized for storing the captured image on the consumer handheld communication device 402. The processor 404 may generate a flash signal that illuminates the flash bulb 408 while capturing the image. The flash signal that illuminates the flash bulb 408 may be generated in instances where there is insufficient ambient light to sufficiently illuminate a subject. Notwithstanding, the invention is so limited, and accordingly, the flash signal that illuminates the flash bulb 408 may further be generated even in instances when it may be determined that there nay be sufficient ambient light to illuminate the subject.

The exemplary wireless device 402 may be utilized in a threatening situation where, for example, imminent harm is perceived by a threatening party. Accordingly, a user of the exemplary wireless device 402 may depress the single button 424, thereby causing the exemplary wireless device 402 to capture and send an image of the threatening party to a policing authority. While the picture is being captured, the exemplary wireless device 402 may generate and audible signal via the speaker 428 warning the threatening party their image is being relayed to the policing authority.

In another embodiment of the invention, the capture and send button 104 may further be configured so that when depressed continuously for a specified interval or a predetermined period of time, the exemplary device such as the wireless telephone 102 may automatically dial at least one emergency telephone number or directory number (DN) such as 911 in the United States or 113 in Europe. In this regard, when the capture and send button 104 is initially depressed, an image may be captured and sent to the authorities and if the capture and send button 104 is continuously depressed for a period of, for example, about five (5) seconds, the exemplary device such as the wireless telephone 102 may additionally dial 911, for example. The emergency number dialed by the exemplary device such as the wireless telephone 102 may be configurable by, for example, a user and/or it may be set as a default value by a service provider. Accordingly, whatever emergency number is utilized in a particular locality may be programmed into the exemplary device such as the wireless telephone 102. The period or interval for which the send button 104 has to be depressed to enable dialing of an emergency number may be configurable or it may be a default value.

The processor 404 may determine an interval for which the received indication is active. If the determined interval is at least equivalent to a specified time period, the processor 404 may dial at least one directory number. The directory number dialed by the processor 404 may be a local emergency number, a default directory number and/or a user specified directory number.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method for processing an image by a consumer handheld communication device, the method comprising:
receiving an indication that a capture and send function is activated;
capturing at least one image by the consumer handheld communication device; and
wirelessly transferring said at least one captured image from the consumer handheld communication device to at least one of a policing authority and a service provider providing wireless service for the consumer handheld communication device.

2. The method according to claim 1, further comprising displaying at least one of an audio and a visual signal during said capturing of said at least one image.

3. The method according to claim 1, further comprising determining configuration settings for capturing said at least one image.

4. The method according to claim 3, further comprising initializing a camera for the consumer handheld communication device utilizing at least a portion of said determined configuration settings.

5. The method according to claim 1, further comprising initializing a camera for the consumer handheld communication device utilizing default configuration settings.

6. The method according to claim 1, further comprising generating at least one high priority data packet for said transferring of said at least one captured image.

7. The method according to claim 6, further comprising placing said generated at least one high priority data packet at the top of a send queue for immediate sending.

8. The method according to claim 1, further comprising storing said at least one captured image at the consumer handheld communication device.

9. The method according to claim 1, further comprising generating a flash signal that illuminates a flash bulb during said capturing of said at least one image.

10. The method according to claim 1, wherein said at least one captured image comprises a still or a video clip.

11. The method according to claim 1, further comprising determining an interval for which said received indication is active.

12. The method according to claim 11, further comprising if said determined interval is at least equivalent to a specified time period, dialing at least one directory number.

13. The method according to claim 12, wherein said at least one directory number is at least one of a local emergency number, a default directory number and a user specified directory number.

14. A machine-readable storage having stored thereon, a computer program having at least one code section for processing an image by a consumer handheld communication device, the at least one code section being executable by a machine for causing the machine to perform steps comprising:
receiving an indication that a capture and send function is activated;
capturing at least one image by the consumer handheld communication device; and
wirelessly transferring said at least one captured image from the consumer handheld communication device to at least one of a policing authority and a service provider providing wireless service for the consumer handheld communication device.

15. The machine-readable storage according to claim 14, further comprising code for displaying at least one of an audio and a visual signal during said capturing of said at least one image.

16. The machine-readable storage according to claim 14, further comprising code for determining configuration settings for capturing said at least one image.

17. The machine-readable storage according to claim 16, further comprising code for initializing a camera for the consumer handheld communication device utilizing at least a portion of said determined configuration settings.

18. The machine-readable storage according to claim 14, further comprising code for initializing a camera for the consumer handheld communication device utilizing default configuration settings.

19. The machine-readable storage according to claim 14, further comprising code for generating at least one high priority data packet for said transferring of said at least one captured image.

20. The machine-readable storage according to claim 19, further comprising code for placing said generated at least one high priority data packet at the top of a send queue for immediate sending.

21. The machine-readable storage according to claim 14, further comprising code for storing said at least one captured image at the consumer handheld communication device.

22. The machine-readable storage according to claim 14, further comprising code for generating a flash signal that illuminates a flash bulb during said capturing of said at least one image.

23. The machine-readable storage according to claim 14, wherein said at least one captured image comprises a still or a video clip.

24. The machine-readable storage according to claim 14, further comprising code for determining an interval for which said received indication is active.

25. The machine-readable storage according to claim 24, further comprising code for dialing at least one directory number if said determined interval is at least equivalent to a specified time period.

26. The machine-readable storage according to claim 25, wherein said at least one directory number is at least one of a local emergency number, a default directory number and a user specified directory number.

27. A system for processing an image by a consumer handheld communication device, the system comprising:
at least one processor that receives an indication that a capture and send function is activated;
a camera that captures at least one image by the consumer handheld communication device; and
at least one transceiver that wirelessly transfers said at least one captured image from the consumer handheld communication device to at least one of a policing authority and a service provider providing wireless service for the consumer handheld communication device.

28. The system according to claim 27, further comprising at least one display that displays at least one of an audio and a visual signal during said capturing of said at least one image.

29. The system according to claim 27, wherein said at least one processor determines configuration settings for capturing said at least one image.

30. The system according to claim 29, wherein said at least one processor initializes a camera for the consumer handheld communication device utilizing at least a portion of said determined configuration settings.

31. The system according to claim 27, wherein said at least one processor initializes a camera for the consumer handheld communication device utilizing default configuration settings.

32. The system according to claim 27, wherein said at least one processor generates at least one high priority data packet for said transferring of said at least one captured image.

33. The system according to claim 32, wherein said at least one processor places said generated at least one high priority data packet at the top of a send queue for immediate sending.

34. The system according to claim 27, further comprising at least one of an internal memory and a removable storage for storing said at least one captured image at the consumer handheld communication device.

35. The system according to claim 27, wherein said at least one processor generates a flash signal that illuminates a flash bulb during said capturing of said at least one image.

36. The system according to claim 27, wherein said at least one captured image comprises a still or a video clip.

37. The system according to claim 27, wherein said at least one processor determines an interval for which said received indication is active.

38. The system according to claim 37, wherein said at least one processor dials at least one directory number if said determined interval is at least equivalent to a specified time period.

39. The system according to claim 38, wherein said at least one directory number is at least one of a local emergency number, a default directory number and a user specified directory number.

40. The system according to claim 27, wherein said at least one processor is a RISC processor, CPU, MIPS processor, ARM processor, DSP, ASIC, microprocessor or microcontroller.
